(19) United States
(12) Patent Application Publication
(10) Pub. No.: US 2026/0068857 A1
(43) Pub. Date: Mar. 12, 2026

(54) BIRD FEEDER WITH CAGE

(71) Applicant: Paul L. COTE, Knowlton (CA)

(72) Inventor: Paul L. COTE, Knowlton (CA)

(21) Appl. No.: 19/325,103

(22) Filed: Sep. 10, 2025

Related U.S. Application Data
(60) Provisional application No. 63/693,897, filed on Sep. 12, 2024.

(51) Int. Cl. A01K 39/01; A01K 39/012

(52) U.S. Cl. CPC A01K 39/0113; A01K 39/012

(57) ABSTRACT

The present disclosure provides a bird feeder having a seed container, seed tray, shroud, cover as well as a cage surrounding the seed tray and lower end of the shroud. The cage has a wide lower end to allow small birds, such as songbirds, through the cage to access the seeds. However, the cage is secured to the shroud such that movement of the cage, due to weight of larger birds, will correspondingly actuate the shroud and move both the cage and shroud downwardly and prevent access to the seeds in the seed tray.

### CROSS REFERENCE TO RELATED APPLICATION

The present application claims priority to U.S. Provisional Application No.63/693,897, entitled “BIRD FEEDER WITH CAGE” filed on Sep. 12, 2024, the contents of which are incorporated herein by reference in their entirety.

### FIELD

The disclosure relates generally to the field of bird feeders, and more specifically to a bird feeder having a cage.

### BACKGROUND

Bird feeders have been around for quite some time for bird watchers and animal lovers. However, many problems exist with current bird feeders, including but not limited to heavier birds, such as grackle, landing on the perches and eating the seeds intended for songbirds.

As such, there is a need for a novel type of bird feeder that can overcome the problems of the prior art.

### SUMMARY

In an aspect the present disclosure provides a bird feeder comprising: a seed container to contain seeds; a seed tray connected to the seed container and adapted to provide access to the seeds; a shroud engaged with the seed tray, the shroud moveable between a first position to provide access to the seeds and a second position to deny access to the seeds; a cage surrounding the seed tray and moveable between the first position and the second position, the cage allowing selective access to the seed tray; and, a cover.

In another aspect, the present disclosure provides a cage for use with a bird feeder comprising: a mesh housing defining a plurality of peripheral openings to allow selective access to a seed tray of the bird feeder, the mesh housing further comprising: an upper end terminating in a connector; and, a lower end terminating in an adapter, wherein the mesh housing is configured to be secured to a shroud of a bird feeder.

### BRIEF DESCRIPTION OF THE DRAWINGS

The following figures serve to illustrate various embodiments of features of the disclosure. These figures are illustrative and are not intended to be limiting.

FIG. 1 is a perspective view of a bird feeder, according to an embodiment of the present disclosure;

FIG. 2 is a perspective cross-sectional view of the lower end of the bird cage of FIG. 1, according to an embodiment of the present disclosure;

FIG. 3 is a front view of the cage of the bird feeder of FIG. 1, according to an embodiment of the present disclosure;

FIG. 4 is an underside perspective view of the cage of the bird feeder of FIG. 1, according to an embodiment of the present disclosure;

FIG. 5 is a perspective view of a bird feeder, according to another embodiment of the present disclosure;

FIG. 6 is a perspective cross-sectional view of the lower end of the bird cage of FIG. 5, according to another embodiment of the present disclosure;

FIG. 7 is a front view of the cage of the bird feeder of FIG. 5, according to another embodiment of the present disclosure;

FIG. 8 is a front view of the bird feeder of FIG. 5 in an open configuration, according to another embodiment of the present disclosure; and,

FIG. 9 is a front view of the bird feeder of FIG. 5 in a closed configuration, according to another embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

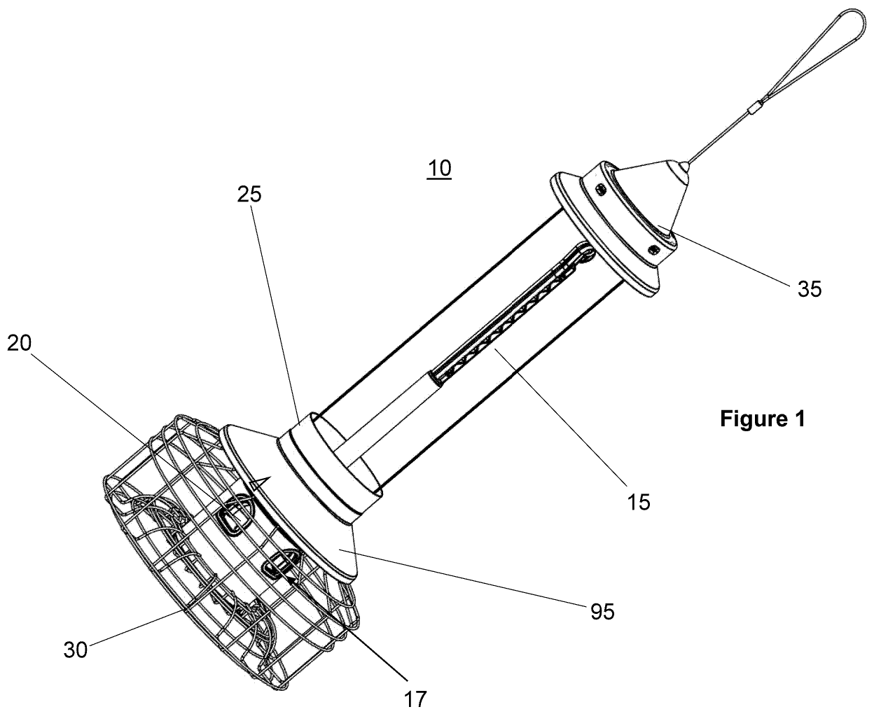

With reference to FIG. 1 and according to an embodiment of the present disclosure, a bird feeder 10 is shown, preferably comprising a seed container 15 to contain seeds, the seed container 15 terminating in a seed tray 20 that is connected to the seed container 15. The seed tray 20 is adapted to provide access to the seeds, either through a plurality of ports 17 or with a singular circular opening. The bird feeder 10 is further comprised of a shroud 25 having a hood portion 95, the shroud 25 engaged with the seed tray 20, the shroud 25 moveable between a first position to provide access to the seeds and a second position to deny access to the seeds. A cage 30 is also shown, the cage 30 surrounding both the lower portion of the shroud 25 and the seed tray 20, the cage 30 being similarly moveable between the first position to the second position. The cage 30 is configured to allow selective access to the ports 17 and thus the seed tray 20 to selectively access the seeds. The seed container 15 is capped by a cover 35 that prevents rain or other debris from entering the seed container 15 from above.

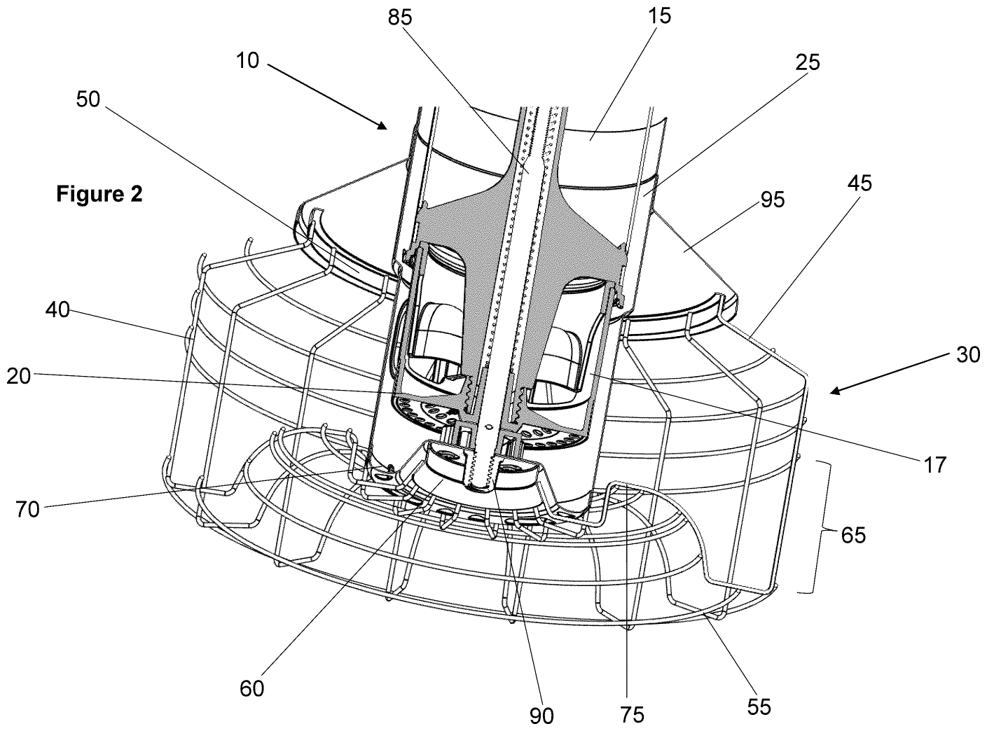

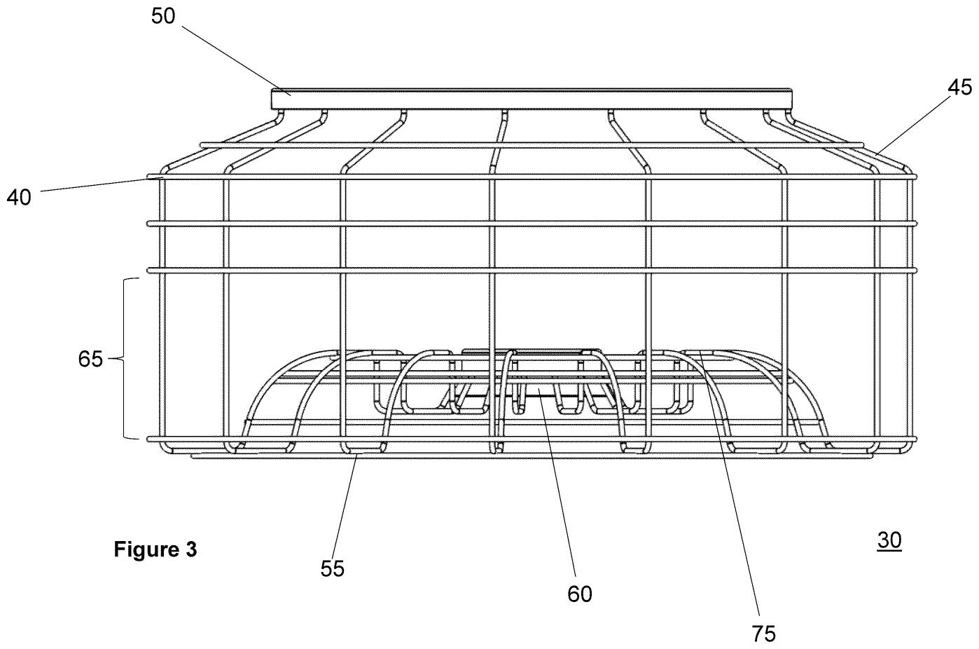

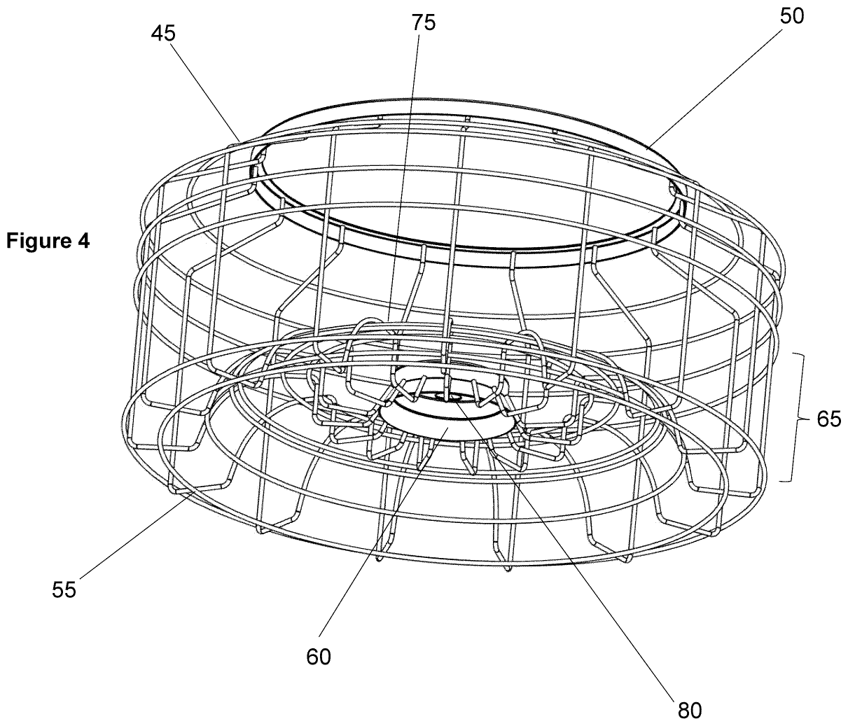

With reference to FIGS. 2, 3 and 4 and according to an embodiment of the present disclosure, the cage 30 is generally comprised of a mesh housing 40. As shown, the mesh housing 40 has a tapered upper end 45 terminating in a connector, the connector in this exemplary embodiment being a ring 50. The mesh housing 40 also has a lower end 55 terminating in an adapter. In this exemplary embodiment, the adapter is a cap 60. The mesh housing 40 is made up of a plurality of wires, the wires defining a wide lower opening 65 that has a sufficient size to allow songbirds and other small birds to fit into the cage 30. The wide lower opening 65 cooperates with the lower end 55 of the mesh housing 40 such that smaller birds fit into the wide lower opening 65 and perch to access the seeds. Specifically, as shown in this embodiment, the lower end 55 of the mesh housing 40 is positioned below the lowermost end 70 of the bird feeder 10, but tapers upwardly to a perch section or position 75, the perch position 75 being positioned below the openings 17. In this way, songbirds and other small birds can perch on the perch position 75 of the mesh housing 40 to eat the seeds. From the perch position 75, the wiring of the mesh housing 40 extends downwardly and up into the cap 60. In an embodiment, the mesh housing 40 is soldered to the cap 60, but other means of attachment are possible. To connect the cage 30 to the bird feeder 10, the ring 50 of the cage 30 is positioned below the shroud 25 and around the lower end of the seed container 15. Then, a central opening 80 of the cap 60 is aligned with and inserted around the end of a central rod 85 of the bird feeder 10. A nut 90 is then fastened below the cap 60 and around the lower end of the central rod 85, which secures the cage 30 to the bird feeder 10. Indeed, once the central opening 80 is positioned around the lower end of the central rod 85, the ring 50 of the cage 30 is positioned against, thereby abutting the hood portion 95 of the shroud 25. In this configuration, the cage 30 is only moveable with the shroud 25. The cage 30 is configured to move up and down with the shroud 25 as weight is placed on the cage 30. Indeed, as larger bird such as grackle land on the bird feeder 10, they will typically do so by landing on the upper end 45 of the cage 30 to access the wide lower opening 65 and therefore the seeds. However, the weight of the larger birds on the cage 30 will overcome the spring mechanism within the bird feeder 10 and move the cage 30 and shroud 25, independently of the seed tray 20 to deny access to the seeds through the ports 17. It is understood that although wide lower openings 65 are disclosed, the openings may be positioned anywhere on the cage 30 so as to allow smaller birds entry into the cage 30 without actuating the spring mechanism and moving the cage 30 and shroud 25 downwardly.

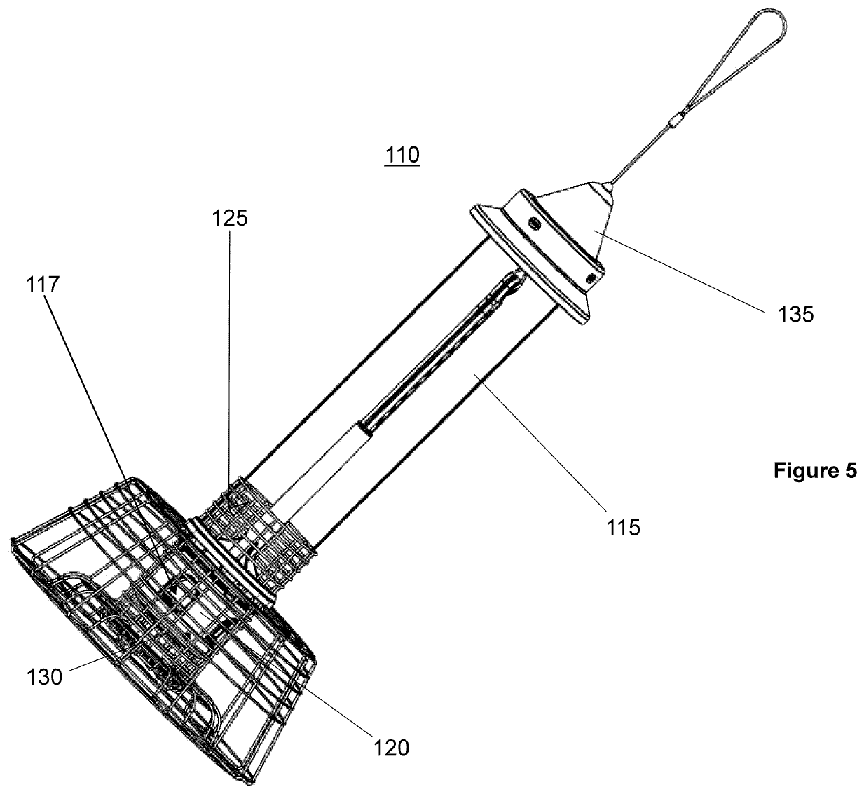

With reference to FIG. 5 and according to an embodiment of the present disclosure, another bird feeder 110 is shown, preferably comprising a seed container 115 to contain seeds, the seed container 115 terminating in a seed tray 120 that is connected to the seed container 115. The seed tray 120 is adapted to provide access to the seeds, either through a plurality of ports 117 or with a singular circular opening. The bird feeder 110 is further comprised of a shroud 125 engaged with the seed tray 120, the shroud 125 moveable between a first position to provide access to the seeds and a second position to deny access to the seeds. A cage 130 is also shown, the cage 130 surrounding both the lower portion of the shroud 125 and the seed tray 120, the cage 130 being similarly moveable between the first position to the second position. The cage 130 is configured to allow selective access to the ports 117 and thus the seed tray 120 to selectively access the seeds. The seed container 115 is capped by a cover 135 that prevents rain or other debris from entering the seed container 115 from above. In this embodiment, the shroud 120 is not comprised of a hood portion.

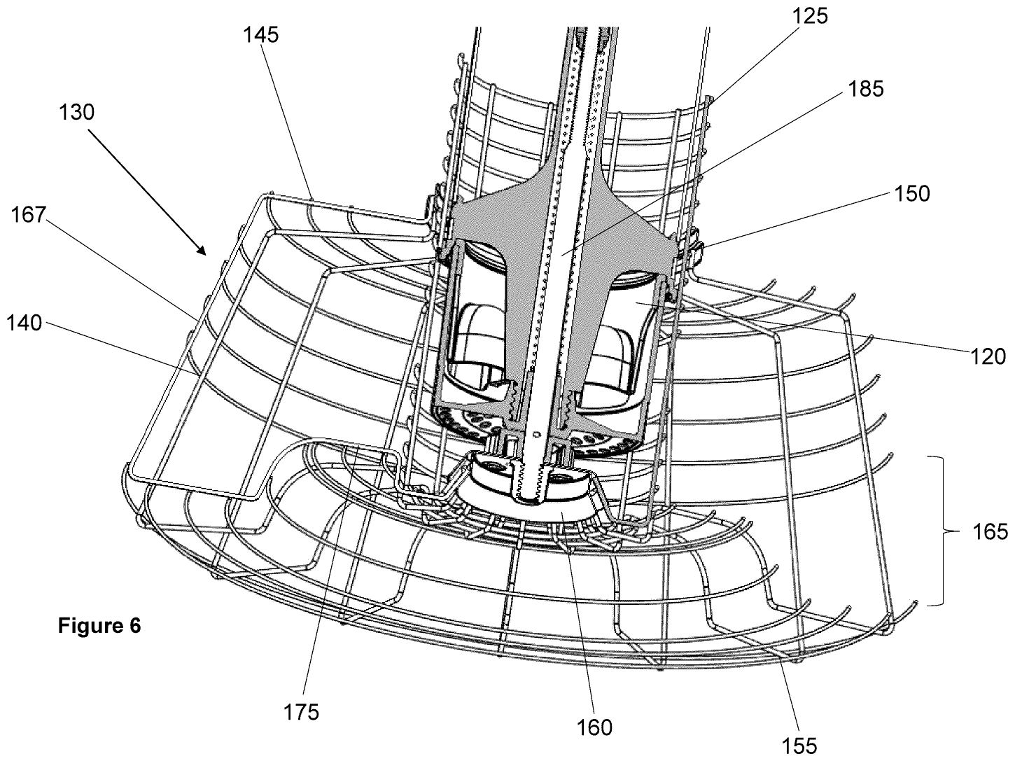

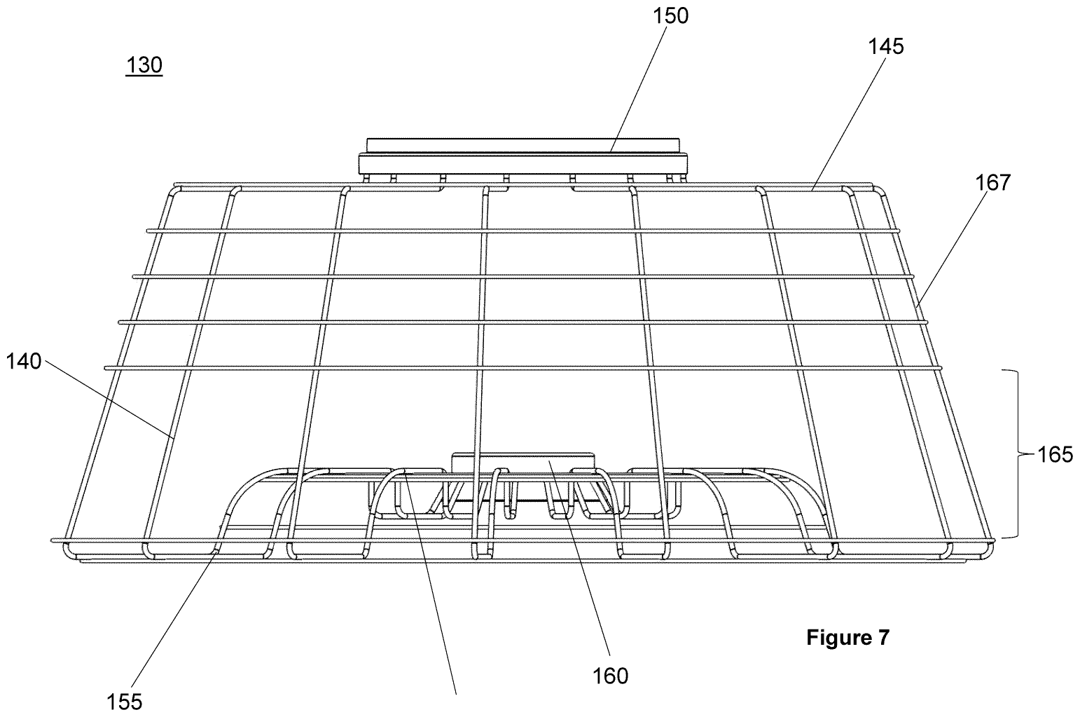

With reference to FIGS. 6 and 7 and according to an embodiment of the present disclosure, the cage 130 is generally comprised of a mesh housing 140. In this embodiment, the mesh housing 140 has a flat upper end 145 terminating in a connector, the connector is this embodiment being a ring 150. The lower end 155 of the mesh housing terminates in an adapter, the adapter being a cap 160. The mesh housing 140 is comprised of a plurality of wires that define an opening 165. The opening 165 is sufficiently large to allow smaller birds, such as songbirds, to enter the cage 130, but sufficiently small to prevent larger birds, such as grackle, from entering the cage 130. Indeed, smaller birds enter the opening 165 to access the seeds contained in the seed tray 120. The mesh housing 140 is comprised of peripheral wires 167 that flare outwardly from the upper end 145 to the lower end 155. The mesh housing 140 has a perch section 175 on which these smaller birds can perch to comfortably access the seeds. It is understood that the mesh configuration of the mesh housing 140 is merely exemplary and not intended to be limiting. In another embodiment, the lower end 155 may be completely flat towards the cap 160. The cap 160 is fitted over and secured to a central rod 185 of the bird feeder so that the cage 130 is secured to the bird feeder. In an embodiment, the cap 160 may be directly secured to the shroud 125 so that the cage 130 and shroud 125 move together and allow or prevent access to the seeds contained in the seed tray 120. In another embodiment, the connector 150 could be instead secured to the shroud 125 by clips, hooks or other means. In yet another embodiment, the cage 130 may be comprised of radial dowels (not shown) or other types of connectors that would secure the cage 130 to the shroud 125.

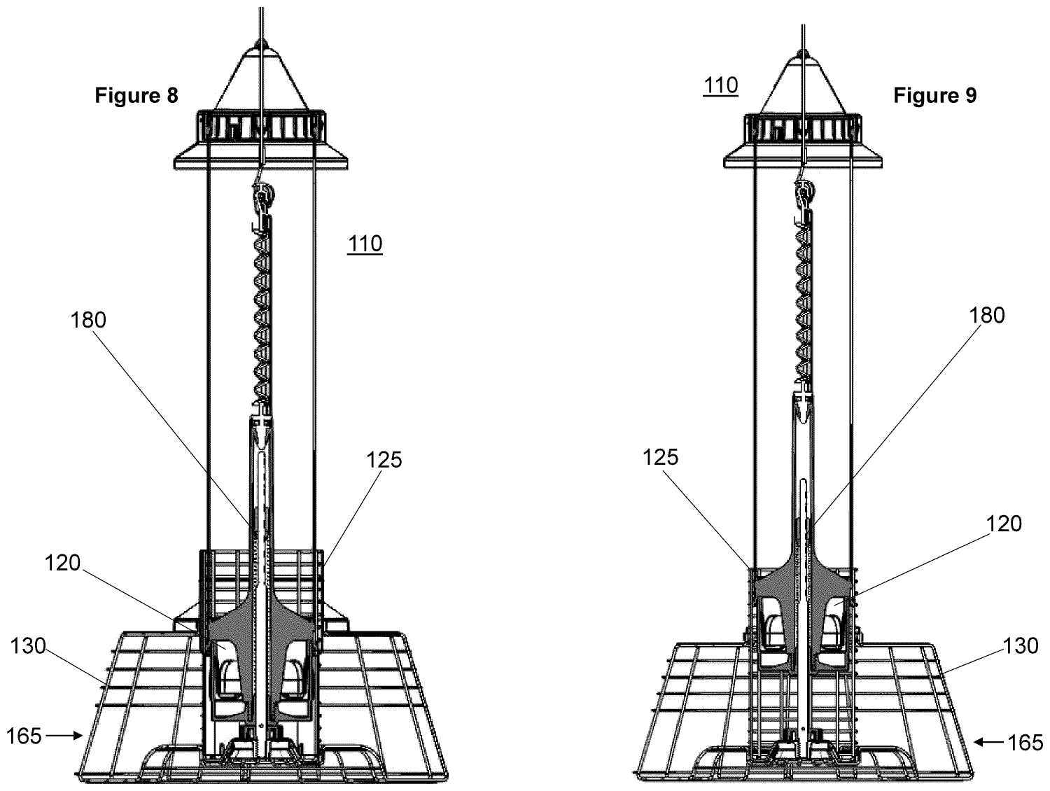

With reference to FIGS. 8 and 9 and according to an embodiment of the present disclosure, the bird feeder 110 is shown in an open configuration (in FIG. 8), where access to the seeds in the seed tray 120 is allowed, and a closed configuration (in FIG. 9), where access to the seeds in the seed tray 120 is prevented. As shown in the open configuration, little to no weight is placed on the cage 130 such that a small songbird can enter the opening 165 and access the seeds. Indeed, there is an actuatable spring mechanism 180 inside the bird feeder 110 that compresses and expands depending on weight placed on the cage 130. Once enough mass is placed on the cage 130, the spring mechanism 180 is compressed and the cage 130 and shroud 125 move downwardly and access to the openings of the seed tray 120 is prevented, as specifically shown in FIG. 9.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A bird feeder comprising:
a seed container to contain seeds;
a seed tray connected to the seed container and adapted to provide access to the seeds;
a shroud engaged with the seed tray, the shroud moveable between a first position to provide access to the seeds and a second position to deny access to the seeds;
a cage surrounding the seed tray and moveable between the first position and the second position, the cage allowing selective access to the seed tray; and,
a cover.

2. The bird feeder of claim 1 wherein the cage is secured to the shroud.

3. The bird feeder of claim 1 wherein the cage is further comprised of an upper end and a lower end, the lower end secured to the shroud and the upper end abutting against the shroud.

4. The bird feeder of claim 3 wherein the upper end abuts against and underneath a hood portion of the shroud.

5. The bird feeder of claim 1 wherein the cage is further comprised of an upper end and a lower end, the lower end having perch portions on which birds can perch.

6. The bird feeder of claim 5 wherein the perch portions are positioned below an opening of the seed tray.

7. The bird feeder of claim 1 wherein the cage is further comprised of openings, the openings to allow selective access to the seed tray.

8. The bird feeder of claim 1 wherein the cage is further comprised of an upper end and a lower end, the lower end abutting against the shroud and the upper end secured to the shroud.

9. The bird feeder of claim 7 wherein the cage is further comprised of an upper end and a lower end, the openings positioned proximate the lower end, the lower end secured to the shroud and the upper end abutting against the shroud.

10. The bird feeder of claim 7 wherein the cage is further comprised of an upper end and a lower end, the openings positioned proximate the lower end, the lower end abutting against the shroud and the upper end secured to the shroud.

11. A cage for use with a bird feeder comprising:
a mesh housing defining a plurality of peripheral openings to allow selective access to a seed tray of the bird feeder, the mesh housing further comprising:
an upper end terminating in a connector; and,
a lower end terminating in an adapter,
wherein the mesh housing is configured to be secured to a shroud of a bird feeder.

12. The bird feeder of claim 11 wherein the adapter is secured to the shroud, and the connector abuts against the shroud.

13. The bird feeder of claim 12 wherein the connector abuts against and underneath a hood portion of the shroud.

14. The bird feeder of claim 11 wherein the lower end has perch portions on which birds can perch.

15. The bird feeder of claim 14 wherein the perch portions are positioned below a hole of the seed tray.

16. The bird feeder of claim 11 wherein the adapter abuts against the shroud and the connector is secured to the shroud.

17. The bird feeder of claim 11 wherein the peripheral openings are positioned proximate the lower end, the adapter secured to the shroud and the connector abutting against the shroud.

18. The bird feeder of claim 11 wherein the peripheral openings are positioned proximate the lower end, the adapter abutting against the shroud and the connector secured to the shroud.
